(19) United States
(12) Patent Application Publication
(10) Pub. No.: US 2022/0332039 A1
(43) Pub. Date: Oct. 20, 2022

(54) A PROCESS FOR PRODUCING A 3D OBJECT BY A FUSED FILAMENT FABRICATION PROCESS

(71) Applicant: BASF SE, Ludwigshafen am Rhein (DE)

(72) Inventors: Rene ARBTER, Ludwigshafen am Rhein (DE); Rudolf SEILER, Ludwigshafen am Rhein (DE); Thorsten Martin STAUDT, Ludwigshafen am Rhein (DE)

(21) Appl. No.: 17/633,975

(22) PCT Filed: Aug. 14, 2020
(86) PCT No.: PCT/EP2020/072914

§ 371 Date: Feb. 9, 2022

(30) Foreign Application Priority Data
Aug. 23, 2019 (DE) 19193260.7

(51) Int. Cl. B29C 64/118; B29C 64/321; B29C 64/295; B29C 64/209; B29C 64/314; B33Y 10/00; B33Y 30/00; B33Y 40/10; B33Y 70/10

(52) U.S. Cl. CPC B29C 64/118; B29C 64/321; B29C 64/295; B29C 64/209; B29C 64/314; B33Y 10/00; B33Y 30/00; B33Y 40/10; B33Y 70/10; B29K 2507/04

(57) ABSTRACT

A process for producing a three-dimensional (3D) object by a fused filament fabrication process employing at least one filament and a three-dimensional (3D) extrusion printer. Within said process, the filament is first fed to a cooling device, where the filament is cooled down to a temperature of 20° C. or colder. Afterwards, the cooled-down filament is transported to a heating device located inside the printing head of the 3D extrusion printer, where the cooled-down filament is heated to a temperature, which is high enough to at least partially melt the filament. The heated filament is extruded through the nozzle of the printing head of the 3D extrusion printer in order to obtain an extruded strand, which in turn is used to form the respective 3D object in a layer by layer way. Further an apparatus is disclosed, to be used within such a fused filament fabrication process or 3D printing technology, respectively.

The present invention relates to a process for producing a three-dimensional (3D) object by a fused filament fabrication process employing at least one filament and a three-dimensional (3D) extrusion printer. Within said process, the filament is first fed to a cooling device, where the filament is cooled down to a temperature of 20° C. or colder. Afterwards, the cooled-down filament is transported to a heating device located inside the printing head of the 3D extrusion printer, where the cooled-down filament is heated to a temperature, which is high enough to at least partially melt the filament. The heated filament is extruded through the nozzle of the printing head of the 3D extrusion printer in order to obtain an extruded strand, which in turn is used to form the respective 3D object in a layer by layer way. The present invention further relates to an apparatus to be used within such a fused filament fabrication process or 3D printing technology, respectively.

A task often encountered in recent times is the production of prototypes and models of polymeric, metallic or ceramic bodies, in particular of prototypes and models exhibiting complex geometries. Especially for the production of prototypes, a rapid production process is necessary. For this so called “rapid prototyping”, different processes are known. One of the most economical is the fused filament fabrication process (FFF), also known as “fused deposition modeling” (FDM) or fused layer modeling (FLM).

The fused filament fabrication process (FFF) is an additive manufacturing technology. A three-dimensional object is produced by extruding a thermoplastic material through a nozzle to form layers as the thermoplastic material hardens after extrusion. The nozzle is heated to heat the thermoplastic material past its melting and/or glass transition temperature and is then deposited by the extrusion head on a base to form the three-dimensional object in a layer-wise fashion. The thermoplastic material is typically selected and its temperature is controlled so that it solidifies substantially immediately upon extrusion or dispensing onto the base with the build-up of multiple layers to form the desired three-dimensional object.

In order to form each layer, drive motors are provided to move the base and/or the extrusion nozzle (dispending head) relative to each other in a predetermined pattern along the x-, y- and z-axis. The FFF-process was first described in U.S. Pat. No. 5,121,329.

Typical materials for the production of three-dimensional objects are thermoplastic materials. The production of three-dimensional metallic or ceramic objects by fused filament fabrication is only possible if the metal or ceramic material has a low melting point so that it can be heated and melted by the nozzle. If the metal or ceramic material has a high melting point, it is necessary to provide the metal or ceramic material in a binder composition to the extrusion nozzle. The binder composition usually comprises a thermoplastic material. When depositing the mixture of a metal or ceramic material in a binder on a base, the formed three-dimensional object is a so called “green body”, which comprises the metal or ceramic material in a binder. To receive the desired metallic or ceramic object, the binder has to be removed and finally the object has to be sintered. The three-dimensional object which is formed after removing the binder is a so called “brown body”; the three-dimensional object which is formed after sintering is a so called “sintered body”.

WO 2016/012486 describes a fused filament fabrication process in which a mixture comprising an inorganic powder and a binder is used to produce a three-dimensional green body. The fused filament fabrication process is followed by a debinding step, in which at least part of the binder is removed from the three-dimensional green body to form a three-dimensional brown body. The debinding step is carried out by treating the three-dimensional green body in an atmosphere comprising a gaseous acid and optionally a carrier gas at temperatures up to 180° C. in order to avoid the condensation of the acid. Suitable acids are inorganic acids such as hydrogen halides and nitric acid, and organic acids such as formic acid and acetic acid. After the debinding step, the formed three-dimensional brown body is sintered to form a three-dimensional sintered body.

WO 2017/009190 describes a filament for the use in a fused filament fabrication process to prepare a three-dimensional green body. The filament comprises a core material which is coated with a layer of shell material. The core material comprises an inorganic powder and a binder. The preparation of the three-dimensional brown body as well as the three-dimensional sintered body can be prepared analogously as described in WO 2016/012486. However, the core-shell-filaments described in WO 2017/009190 are more stable and can be easily rolled on a spool, which renders them easier to store and process than those disclosed in WO 2016/012486.

Filaments based on a core material comprising a fibrous filler are disclosed within the international application PCT/EP2019/054604. The respective filament comprises a core material (CM) comprising a fibrous filler (FF) and a thermoplastic polymer (TP1). The core material (CM) is coated with a layer of a shell material (SM) comprising a thermoplastic polymer (TP2). The respective filaments can be employed within a process for the preparation of a three-dimensional object employing the fused filament fabrication technique.

US 2018/0345573 discloses an additive manufacturing system configured to a 3D print using a metal wire material which includes a drive mechanism configured to feed the metal feedstock into an inlet tube and a liquefier.

The article “3D printing of shape memory polymer for functional part fabrication” (Yang Yang et al., The International Journal of Advanced Manufacturing Technology, 2016, 84, 2079-2095) presents a novel method of shape memory polymer (SMP) processing for additive manufacturing, in particular, fused-deposition modelling (FDM).

WO 2018/204749 discloses a filament straightener for straightening a filament for use in an additive manufacturing machine.

CN 106 915 075 discloses a melt deposition type 3D printer spray head cooling device which comprises a spray head hot end assembly, the hot end assembly is connected with a Venturi assembly through a threaded structure, the Venturi assembly is connected with a Venturi cooling assembly through a threaded structure, the Venturi cooling assembly is connected with a wire feeding mechanism through a fixing frame, the Venturi cooling assembly is connected with a refrigerating device through a first cooling pipe connector and a second cooling pipe connector, and a control device is connected with the spray head hot end assembly through a power line.

Despite the fact that the FFF/FDM 3D printing technique has been widely used in practice for many years, still some disadvantages are connected with this 3D printing technique. In case the filament to be employed is too soft (such as having a shore A hardness of ≤80) and/or the respective filaments are not stiff enough, problems occur during the 3D printing process within the printing head of the respective 3D extrusion printer. This is due to the fact that the feed force is limited causing a bending or buckling of the respective filament within the printing head of the 3D extrusion printer.

By consequence, the melting speed within the nozzle is limited and the printing process as such is slower or even stopped. Furthermore, waste due to canceling the printing process occurs rather often.

Therefore, the object underlying the present invention is to provide a new process for producing three-dimensional objects by a fused filament fabrication process that do not exhibit the above-mentioned disadvantages of the prior art or only to a lesser extent.

This object is achieved by a process for producing a three-dimensional (3D) object by employing a three-dimensional (3D) printing process comprising the steps a) to e) as follows:
a) feeding the at least one filament into a cooling device in order to cool down the at least one filament to a temperature T₁≤20° C.,
b) transporting the at least one cooled-down filament obtained in step a) to a heating device located inside the printing head of the 3D extrusion printer,
c) heating the at least one cooled-down filament within the heating device to a temperature T₂, wherein the temperature T₂ is high enough to at least partially melt the at least one filament,
d) extruding the at least one heated filament obtained in step c) through the nozzle of the printing head of the 3D extrusion printer in order to obtain at least one extruded strand,
e) forming the 3D object layer by layer from the at least one extruded strand obtained in step d).

One advantage of the present invention can be seen in the fact that that the stiffness of the filament can be changed/governed during the operation of the 3D printing process. Since the respective filament is cooled down to a rather low temperature in a step prior to heating/extruding the respective filament, rather soft filaments can be printed more easily and/or faster since the stiffness of the respective filament is increased due to the cooling step. By consequence, a bending or buckling of the respective filament within the printing head can be avoided, especially in case a Bowden printer/Bowden extruder is used.

Another effect caused by the cooling step can be seen in the increased surface hardness of the respective filament. This causes an improvement in the accuracy of the feed, especially in case a conveyor unit is used, wherein, for example, gears contained within said conveyor unit are in contact with the surface of the respective filament. Beyond that, friction of soft filaments on guiding elements such as Bowden tubes is reduced, which has a positive impact on the realization of longer feed distances. Longer feed distances are important in case a Bowden extruder is used within the 3D extrusion printing process.

Another advantage of the cooling step can be seen in the fact that a re-tracking of (rather flexible) filaments in case of a bending of the respective filament within the printing head of the 3D extrusion printer is easier and more precise.

The invention is specified in more detail as follows.

A first subject matter of the present invention is a process for producing a three-dimensional (3D) object by a fused filament fabrication process employing at least one filament and a three-dimensional (3D) extrusion printer comprising the steps a) to e) as follows:
a) feeding the at least one filament into a cooling device in order to cool down the at least one filament to a temperature T₁≤20° C.,
b) transporting the at least one cooled-down filament obtained in step a) to a heating device located inside the printing head of the 3D extrusion printer,
c) heating the at least one cooled-down filament within the heating device to a temperature T₂, wherein the temperature T₂ is high enough to at least partially melt the at least one filament,
d) extruding the at least one heated filament obtained in step c) through the nozzle of the printing head of the 3D extrusion printer in order to obtain at least one extruded strand,
e) forming the 3D object layer by layer from the at least one extruded strand obtained in step d).

As already described above, the three-dimensional (3D) printing technique according to the fused filament fabrication (FFF) process as such is known to a person skilled in the art. By consequence, also three-dimensional (3D) extrusion printers as such suitable to be employed within a 3D printing process, particularly within a FFF printing process, are known to the person skilled in the art. Additionally, any filaments as such which can be employed within any conventional 3D printing process, in particular within any conventional FFF printing process, can also be employed within the present invention. Such filaments as well as a method for producing such filaments are known to the person skilled in the art. For example, specific filaments may be prepared from the respective (polymeric) composition by extrusion of granulates of the respective (polymeric) composition. Suitable filaments to be employed within the context of the present invention are disclosed, for example, within WO 2016/012486, WO 2017/009190 or PCT/EP 2019/054604.

Specific examples of filaments which can be employed within the process of the present invention are selected from
i) a filament comprising at least one polymer, preferably at least one thermoplastic polymer,
ii) a filament comprising at least one inorganic powder and at least one polymer, preferably the inorganic powder is a powder of at least one inorganic material selected from the group consisting of a metal, a metal alloy and a ceramic material,
iii) a filament comprising at least one core material (CM) coated with a layer of at least one shell material (SM), or
iv) a filament comprising at least one fibrous filler (FF) and at least one polymer, preferably the fibrous filler (FF) is at least one carbon fiber,

preferably the at least one filament is selected from a filament comprising at least one fibrous filler (FF) and at least one polymer, preferably the fibrous filler (FF) is at least one carbon fiber.

Any filament which may be employed within the process according to the process of the present invention, such as those as exemplified above, may exhibit any length and/or diameter as deemed appropriate by the person skilled in the art. Preferably, the diameter of the filament is 1 to 3 mm, more preferably 1.2 to 1.8 mm, most preferably 1.4 to 2.6 mm. The length of the respective filaments is usually not limited to any specific value, the respective filament may have a length even up to several meters. Usually, such filaments are rolled on a spool.

In case the respective filament contains at least one fibrous filler (FF), any fibrous filler which is known to a person skilled in the art can be employed. Preferably, the at least one fibrous filler (FF) is selected from synthetic fibers and inorganic fibers, preferably from aramid fibers, glass fibers and carbon fibers, more preferably from glass fibers composed of E, A, or C glass and carbon fibers, most preferably from carbon fibers.

In one embodiment of the present invention, the at least one filament is a filament comprising a core material (CM) coated with a layer of a shell material (SM). Such filaments are disclosed for example within WO 2017/009190 or PCT/EP 2019/054604. In case the respective filament employed within the context of the present invention is a core/shell filament, it is preferred that the at least one filament is a filament comprising a core material (CM) coated with a layer of shell material (SM), wherein the core material (CM) comprises the components a) to c)
a) at least one fibrous filler (FF),
b) at least one thermoplastic polymer (TP1), and
c) optionally at least one additive (A),

and the shell material (SM) comprises the components d) to f)
d) at least one thermoplastic polymer (TP2),
e) optionally at least one fibrous filler (FF), and
f) optionally at least one additive (A).

The layer of shell material (SM) may have any thickness as deemed appropriate by the person skilled in the art.

Preferably, the thickness of the layer of shell material (SM) is 0.04 to 0.6 mm, more preferably 0.06 to 0.3 mm.

The core material (CM) may have any diameter as deemed appropriate by the person skilled in the art.

Preferably, the diameter of the core material (CM) is 1 to 2 mm, more preferably 1.2 to 1.8 mm, most preferably 1.4 to 1.6 mm.

The core material (CM) may comprise the at least one fibrous filler (FF) in any amount as deemed appropriate by a person skilled in the art. Preferably, the core material (CM) comprises 10 to 50% by weight of the at least one fibrous filler (FF), more preferably 15 to 45% by weight, and most preferably 20 to 40% by weight, based on the total weight of the core material (CM).

As component a), any known fibrous filler (FF) can be used. Preferably, the at least one fibrous filler (FF) is selected from the group consisting of natural fibers, synthetic fibers and inorganic fibers.

Examples for suitable natural fibers are cellulose fibers, protein fibers and polylactide fibers.

Examples for suitable synthetic fibers are aramid fibers, polyacrylic fibers and polyester fibers such as polyethylene terephthalate fibers or polybutylene terephthalate fibers.

Examples for suitable inorganic fibers are ceramic fibers, glass fibers, carbon fibers and basalt fibers.

In case the fibrous fillers (FF) are glass fibers, the glass fibers are preferably composed of E, A, or C glass. The glass fibers can be used as rovings (continuous-filament fibers) or in the commercially available forms of chopped glass fibers (staple).

The at least one thermoplastic polymer (TP1) may comprise thermoplastic homopolymers, thermoplastic copolymers, as well as blends of thermoplastic polymers.

The core material (CM) may comprise the at least one thermoplastic polymer (TP1) in any amount as deemed appropriate by a person skilled in the art. Preferably, the core material (CM) comprises 50 to 90% by weight of the at least one thermoplastic polymer (TP1), more preferably 55 to 85% by weight and most preferably 60 to 80% by weight, based on the total weight of the core material (CM).

As component b), any known thermoplastic polymers can be used. Preferably, the at least one thermoplastic polymer (TP1) of the core material (CM) is selected from the group consisting of impact-modified vinylaromatic copolymers, thermoplastic elastomers based on styrene (S-TPE), polyolefins (PO), aliphatic-aromatic copolyesters, polycarbonates, thermoplastic polyurethanes (TPU), polyamides (PA), polyphenylene sulfides (PPS), polyaryletherketones (PAEK), polysulfones and polyimides (PI), more preferably from impact-modified vinylaromatic copolymers, polyolefins (PO), aliphatic-aromatic copolyesters and polyamides (PA).

The at least one thermoplastic polymer (TP1) of the core material (CM) can be selected from impact-modified vinylaromatic copolymers.

Impact-modified vinylaromatic copolymers are known per se and are commercially available.

Preferred impact-modified vinylaromatic copolymers are impact-modified copolymers composed of vinylaromatic monomers and of vinyl cyanides (styrene acrylonitrile copolymers (SAN)). The preferred impact-modified SAN used preferably comprise acrylonitrile styrene acrylate (ASA) polymers and/or acrylonitrile butadiene styrene (ABS) polymers, or else (meth)acrylate-acrylonitrile-butadiene-styrene polymers (“MABS”, transparent ABS), or else blends of SAN, ABS, ASA, and MABS with other thermoplastics, for example with polycarbonate, with polyamide (PA), with polyethylene terephthalate (PET), with polybutylene terephthalate (PBT), with polyvinyl chloride (PVC), or with polyolefins (PO).

The at least one thermoplastic polymer (TP1) of the core material (CM) can also be selected from thermoplastic polyurethanes (TPU).

Thermoplastic polyurethanes (TPU) are polymers having carbamate units. Thermoplastic polyurethanes as well as their preparation are known to the skilled person.

Such thermoplastic polyurethanes (TPU) which can be employed as a thermoplastic polymer (TP1) within this embodiment of the present invention are disclosed within PCT/EP 2019/054604 or within the below mentioned further embodiments of filaments to be employed within the context of the present invention.

The core material (CM) may comprise the at least one additive (A) in any amount as deemed appropriate by a person skilled in the art. Preferably, the core material (CM) comprises 0 to 20% by weight, more preferably 0 to 15% by weight, and most preferably 0 to 10% by weight, based on the total weight of the core material (CM) of the at least one additive (A).

As component c), any known additives (A) can be used. Preferably, the additive (A) is selected from the group consisting of dispersants, stabilizers, pigments and tackifiers.

The shell material (SM) comprises the components d) to f).

As component d), the shell material (SM) comprises the at least one thermoplastic polymer (TP2).

The at least one thermoplastic polymer (TP2) may comprise thermoplastic homopolymers, thermoplastic copolymers, as well as blends of thermoplastic polymers.

The shell material (SM) may comprise the at least one thermoplastic polymer (TP2) in any amount as deemed appropriate by a person skilled in the art. Preferably, the shell material (SM) comprises 75 to 100% by weight, more preferably 80 to 98% by weight, and most preferably 90 to 95% by weight, based on the total weight of the shell material (SM), of the at least one thermoplastic polymer (TP2).

As component d), the person skilled in the art may select any technical appropriate thermoplastic polymer.

The thermoplastic polymer (TP2) in the shell material (SM) may be
i) the same as the at least one thermoplastic polymer (TP1) of the core material (CM), or
ii) different from the at least one thermoplastic polymer (TP1) of the core material (CM).

Preferably, the at least one thermoplastic polymer (TP2) of the shell material (SM) is selected from the group consisting of polyoxymethylene (POM), impact-modified vinylaromatic copolymers, thermoplastic elastomers based on styrene (S-TPE), polyolefins (PO), thermoplastic polyurethanes (TPU), polyamides (PA), polyethers (PETH), polycarbonates (PC), polyesters (PES), polyphenylene sulfides (PPS), polyaryletherketones (PAEK), polysulfones and polyimides (PI), preferably from polyolefins (PO), thermoplastic polyurethanes (TPU), polyamides (PA), polycarbonates (PC), polyesters (PES), polyphenylene sulfides (PPS), polyaryletherketones (PAEK), polysulfones and polyimides (PI).

The optional components e) and f) which may be present within the shell material may be selected from the same kind of specific components as described above for the components b) or c), which are contained within the core material (CM).

In a preferred embodiment of the present invention, the at least one filament to be employed comprises at least one thermoplastic polyurethane (TPU). More preferably, the respective at least one filament is entirely made of at least one thermoplastic polyurethane. Thermoplastic polyurethanes as such are known to a person skilled in the art and are disclosed, for example, within WO 2016/184771 or as a filament in one embodiment of PCT/EP 2019/054604.

Preferably, the at least one thermoplastic polyurethane is obtainable by polymerization of the following components:
(a) one or more organic diisocyanates,
(b) one or more compounds reactive toward isocyanate,
(c) one or more chain extenders, preferably having a molecular weight of from 60 g/mol to 499 g/mol, and
(d) optionally at least one catalyst, and/or
(e) optionally at least one auxiliary, and/or
(f) optionally at least one additive.

A suitable thermoplastic polyurethane for example has a number average molecular weight in the range of from 8*104 g/mol to 1.8*105 g/mol, more preferably in the range of from 1.0*105 g/mol to 1.5*105 g/mol.

The components (a), (b), (c) and optional components (d), (e) and (f) are generally known from the state of the art and are described by way of example in the following.

Suitable organic diisocyanates (a) are customary aliphatic, cycloaliphatic, araliphatic and/or aromatic isocyanates. Examples thereof include but are not limited to trimethylene diisocyanate, tetramethylene diisocyanate, pentamethylene diisocyanate, hexamethylene diisocyanate, heptamethylene diisocyanate and/or octamethylene diisocyanate, 2-methylpentamethylene 1,5-diisocyanate, butylenes 1,4-diisocyanate, 2-ethylbutylene 1,4-diisocyanate, pentamethylene 1,5-diisocyanate, 1-iso-cyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′- and/or 2,2′-diisocyanate (H12MDI), diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyldiphenyl diisocyanate, 1,2-diphenylethane diisocyanate, phenylene diisocyanate, and any combination thereof.

Suitable organic diisocyanates are also 2,4-paraphenylenediisocynate (PPDI) and 2,4-tetramethylenexylenediisocyante (TMXDI).

Diphenylmethane 2,2′-, 2,4′- and/or 4,4′-diisocyanate (MDI), and dicyclohexylmethane 4,4′-, 2,4′- and/or 2,2′-diisocyanate (H12MDI) are preferred. Diphenylmethane 2,2′-, 2,4′- and/or 4,4′-diisocyanate are particularly preferred.

It is also possible that the organic diisocyanate (a) is an isocyanate mixture comprising at least 90% by weight, more preferably at least 95% by weight, further preferably at least 98% by weight 4,4′-diphenylmethane diisocyanates (4,4′-MDI), and the remaining is other diisocyanates.

Generally, the isocyanate is either used as a single isocyanate or a mixture of isocyanates.

Generally, any suitable known component (b) can be used in the context of the present invention. The compounds (b) which are reactive toward isocyanate are preferably polyhydric alcohols, polyesterols (i.e. polyester polyols), polyetherols (i.e. polyether polyols), and/or polycarbonate diols, for which the collective term“polyols” is also usually used. The number average molecular weights (Mn) of these polyols are from 0.5 kg/mol to 8 kg/mol, preferably from 0.6 kg/mol to 5 kg/mol, very preferably from 0.8 kg/mol to 3 kg/mol, in particular 1 kg/mol to 2 kg/mol.

These polyols in addition preferably have only primary hydroxy groups. The polyols are particularly preferably linear hydroxyl-terminated polyols. Owing to the method of production, these polyols often comprise small amounts of nonlinear compounds. They are therefore frequently also referred to as “essentially linear polyols”.

The polyol is either used as a single polyol or a mixture of polyols. In another preferred embodiment, the polyol is a mixture of two or more polyols. In one preferred embodiment, it is a mixture of polyester polyols and other polyols such as polyester polyols, polyether polyols and/or polycarbonate diols as compounds (b). Polyester polyols, and a mixture of one or more polyether polyols are particularly preferred.

In case of a mixture of polyols, at least one polyester polyol is used in an amount of more than 40% by weight, preferably more than 60% by weight, more preferably more than 80% by weight, and most preferably more than 90% by weight, based on the total weight of the mixture.

Polyether diols, polyester diols and polycarbonate diols in the invention are those commonly known and frequently used in preparation of thermoplastic polyurethanes.

The polyester diols can be based on dicarboxylic acids having from 2 to 12 carbon atoms, preferably from 4 to 8 carbon atoms, which are generally known for the preparation of polyester diols and polyhydric alcohols.

Examples of polyhydric alcohols are alkanediols having from 2 to 10, preferably from 2 to 6, carbon atoms, e.g. ethanediol, 1,3-propanediol, 1,4-butanediol, 1,5-pentanediol, 1,6-hexanediol, 1,10-decanediol, 2,2-dimethyl-1,3-propanediol, 2-methyl-1,3-propanediol, 1,2-propanediol, 3-methyl-1,5-pentanediol, and dialkylene ether glycols such as diethylene glycol and dipropylene glycol. Another examples of polyhydric alcohols are 2,2-Bis(hydroxymethyl)1,3-propanediol and trimethylolpropane. Depending on the desired properties, the polyhydric alcohols can be used either alone or, if appropriate, in mixtures with one another. To keep the glass transition temperature Tg of the polyol very low, it can be advantageous to use a polyester diol based on branched diols, particularly preferably based on 3-methyl-1,5-pentanediol and 2-methyl-1,3-propandiol. The polyester diol is particularly preferably based on at least two different diols, i.e. polyester diols which are prepared by condensation of dicarboxylic acids with a mixture of at least two different diols. In case of a mixture of diols of which at least one is a branched diol, e.g. 2-methyl-1,3-propane diol, the amount of branched diols is more than 40% by weight, preferably more than 70% by weight, more preferably more than 90% by weight, based on the total weight of the diols mixture.

Preferred dicarboxylic acids are, for example: aliphatic dicarboxylic acids, such as succinic acid, glutaric acid, suberic acid, azelaic acid, sebacic acid and preferably adipic acid and aromatic dicarboxylic acids such as phthalic acid, isophthalic acid and terephthalic acid. The dicarboxylic acids can be used individually or as mixtures, e.g. in the form of a mixture of succinic acid, glutaric acid and adipic acid. Mixtures of aromatic and aliphatic dicarboxylic acids can likewise be used. To prepare the polyesterols, it may be advantageous to use the corresponding dicarboxylic acid derivatives such as dicarboxylic esters having from 1 to 4 carbon atoms in the alcohol radical, dicarboxylic anhydrides or dicarboxylic acid chlorides in place of the dicarboxylic acids. The polyester diol is particularly preferably based on adipic acid. In yet another embodiment Polyester polyols based on ε-caprolactone is preferred.

Suitable polyester polyols, for example, may have a number average molecular weight (Mn) ranging from 0.5 to 3 kg/mol, preferably 0.8 kg/mol to 2.5 kg/mol, more preferably from 1 kg/mol to 2 kg/mol, and in particular 1 kg/mol.

Suitable polyether polyols can be prepared by reacting one or more alkylene oxides having from 2 to 4 carbon atoms in the alkylene radical with a starting material molecule containing two active hydrogen atoms. Typical alkylene oxides are ethylene oxide, 1,2-propylene oxide, epichlorohydrin, and 1,2- and 2,3-butylene oxide. Ethylene oxide and mixtures of 1,2-propylene oxide and ethylene oxide are preferably utilized. The alkylene oxides can be used individually, alternately in succession or as mixtures. The typical starting material molecules are, for example water, amino alcohols such as N-alkyldiethanolamines, and diols, ethyleneglycol, 1,3-propyleneglycol, 1,4-butanediol and 1,6-hexanediol. It is also possible to use mixtures of starting material molecules. Suitable polyether polyols also include hydroxyl group-containing polymerization products of tetrahydrofuran.

Preferably used are hydroxyl group-containing polytetrahydrofuran, and co-polyether polyols of 1,2-proplyene oxide and ethylene oxide in which more than 50 percent of the hydroxyl groups are primary hydroxyl groups, preferably from 60 to 80 percent, and in which at least part of the ethylene oxide is a block in terminal position.

Most preferred polyether polyol is hydroxyl group-containing polytetrahydrofuran having a number average molecular weight in the range from 0.6 to 3 kg/mol, preferably from 0.8 to 2.5 kg/mol, more preferably from 1 kg/mol to 2 kg/mol.

A preferred polyol is a mixture of at least one polyester polyol and at least one polyether polyol.

Examples of polyether polyols include but are not limited to those based on generally known starting materials and customary alkylene oxides.

The polyols which can be used in the context of the present invention can either react with isocyanates to produce isocyanate prepolymer or react with isocyanate prepolymers to produce thermoplastic polyurethanes.

Suitable polyols used for reacting with isocyanates to produce an isocyanate prepolymer may have an average functionality >2, preferably between 2.1 and 3, more preferably between 2.1 and 2.7, and most preferably between 2.2 and 2.5. Furthermore, suitable polyols used for reacting with isocyanate prepolymers to produce TPU preferably have an average functionality of from 1.8 to 2.3, preferably from 1.9 to 2.2, in particular 2. The term “functionality” means the number of groups which react with isocyanate under condition of polymerization.

As chain extenders (c), generally known aliphatic, araliphatic, aromatic and/or cycloaliphatic compounds having a molecular weight of from 60 g/mol to 499 g/mol, preferably from 60 g/mol to 400 g/mol can be used, more preferably bifunctional compounds, for example diamines and/or alkane diols having from 2 to 10 carbon atoms in the alkylene radical, in particular 1,2-ethylene diol, 1,4-butanediol, 1,6-hexanediol, 1,3-propanediol, and/or dialkylene-, trialkylene-, tetraalkylene-, pentaalkylene-, hexaalkylene-, heptaalkylene-, octaalkylene-, nonaalkylene- and/or decaalkylene-glycols having from 2 to 8 carbon atoms in alkylene moiety, preferably corresponding oliogopropyleneglycols and/or polypropyleneglycols. It is also possible to use mixtures of the chain extenders. Preference is given to 1,4-butanediol, 1,2-ethylenediol, 1,6-hexanediol or combination thereof as chain extender.

In a preferred embodiment, chain extender (c) is used in an amount of from 2% to 20% by weight, preferably from 5% to 15% by weight, based on the total weight of components (a), (b) and (c).

As chain extender either a single chain extender or a mixture of chain extenders is used.

Suitable catalysts (d), which, in particular, accelerate the reaction between NCO groups of the organic diisocyanates (a) and the polyols (b) and component (c) are tertiary amines which are known and customary in the prior art, for example, triethylamine, dimethylcyclohexylamine, N-methylmorpholine, 2-(dimethyl-aminoethoxy)ethanol, N,N′-dimethylpiperazine, diazabicyclo[2.2.2]octane and the like, and also, in particular, organic metal compounds such as titanic esters, bismuth carboxylic esters, zinc esters, iron compounds such as iron (III) acetylacetonate, tin compounds, e.g. tin diacetate, tin dioctoate, tin dilaurate or dialkyl tin salts of aliphatic carboxylic acids, e.g. dibutyltin diacetate, dibutyltin dilaurate or the like. In bismuth salts oxidation state of the bismuth is preferably 2 or 3, more preferably 3.

Preferred carboxylic acids of bismuth carboxylic esters have 6 to 14 carbon atoms, more preferred 8 to 12 carbon atoms. Preferred examples of bismuth salts are bismut(III)-neodecanoat, bismut-2-etyhlhexanoat and bismut-octanoat.

The catalysts, if used, are usually used in amounts of from 0.0001 to 0.1 parts by weight per 100 parts by weight of polyols (b). Preference is given to tin catalysts, in particular tin dioctoate.

Apart from catalysts (d), customary auxiliaries (e) and/or additives (f) can be added, if desired, in addition to components (a) to (c).

As auxiliaries (e), for example surface-active substances, flame retardants, nucleating agents, lubricant wax, dyes, pigments, and stabilizers, e.g. against oxidation, hydrolysis, light, heat or discoloration may be used, and as additives (f), for example inorganic and/or organic fillers and reinforcing materials. As hydrolysis inhibitors, preference is given to oligomeric and/or polymeric aliphatic or aromatic carbodiimides. To stabilize thermoplastic polyurethanes against aging, stabilizers can also be added.

Further details regarding optional auxiliaries and additives may be found in the specialist literature, e.g. in Plastics Additive Handbook, 5th edition, H. Zweifel, ed, Hanser Publishers, Munich, 2001.

Besides the stated components a), b), and c) and, if appropriate, d) and e) it is also possible to use chain regulators, usually having a number average molecular weight of 31 g/mol to 3 kg/mol. These chain regulators are compounds which have only one isocyanate-reactive functional group, such as monofunctional alcohols, monofunctional amines and/or monofunctional polyols, for example. Chain regulators of this kind allow a precise rheology to be set, particularly in the case of TPUs. Chain regulators can be used generally in an amount of 0 to 5, preferably 0.1 to 1, part(s) by weight, based on 100 parts by weight of component b), and in terms of definition are included in component (c).

To adjust the hardness of the thermoplastic polyurethane, component (b) which is reactive toward isocyanates and chain extenders (c) can be varied within a relatively wide range of molar ratios. Molar ratios of component (b) to the total of chain extenders (c) to be used from 10:1 to 1:10, in particular from 1:1 to 1:4, have been found to be useful, with hardness of the thermoplastic polyurethane increasing with increasing content of (c).

Suitable thermoplastic polyurethanes preferably have a Shore A hardness of generally less than Shore A 98 in accordance with DIN 53505, more preferred from 60 Shore A to 98 Shore A, even more preferred from 70 Shore A to 95 Shore A, and most preferred from 75 Shore A to 90 Shore A.

Preferably, a thermoplastic polyurethane suitable in the context of the present invention has a density in a range from 1.0 g/cm3 to 1.3 g/cm3. The tensile strength of the thermoplastic polyurethane in accordance with DIN 53504 is more than 10 MPa, preferably more than 15 MPa, particularly preferably more than 20 MPa. The thermoplastic polyurethane suitable in the context of the present invention has an abrasion loss in accordance with DIN 53516 of generally less than 150 mm³, preferably less than 100 mm³.

In general, thermoplastic polyurethanes are prepared by reacting (a) isocyanates with (b) compounds reactive toward isocyanates, usually having a number average molecular weight (Mn) of from 0.5 kg/mol to 10 kg/mol, preferably from 0.5 kg/mol to 5 kg/mol, particularly preferably from 0.8 kg/mol to 3 kg/mol, and (c) chain extenders having a number average molecular weight (Mn) of from 0.05 kg/mol to 0.499 kg/mol, if appropriate in the presence of (d) catalysts and/or (e) conventional additives.

The thermoplastic polyurethane may be produced by two different kinds of processes, namely “one-step” processes and “two-step” process which are known from the state of the art.

According to step (ii), to the molten thermoplastic polyurethane, the isocyanate prepolymer composition is added and the resulting mixture is mixed to form a melt. Suitable isocyanate prepolymers are described in the following by way of example.

In such a process, the isocyanate prepolymer composition preferably is heated and used at temperature above 20° C. to have better flowability, the temperature of the isocyanate prepolymer composition preferably is lower than 80° C. to avoid undesired reactions, e.g. allophante cross linking.

For the purpose of the present invention, the term “isocyanate prepolymer” refers to the reaction product of isocyanates with compounds which are reactive toward isocyanates and have a number average molecular weight in the range from 0.5 kg/mol to 10 kg/mol, preferably from 1 kg/mol to 5 kg/mol. Isocyanate prepolymers are intermediates of the isocyanate polyaddition reaction. In a preferred embodiment the prepolymer has a glass transition temperature Tg below −15° C. and a melting temperature below 70° C. measured by means of DSC in accordance with DIN EN ISO 11357-1.

Suitable isocyanate prepolymers may have preferably a NCO content of from 4 to 27 parts by weight based on the weight of the isocyanate prepolymer. Suitable isocyanate prepolymer according to the invention may be used in the form of a single isocyanate prepolymer or a mixture of isocyanate prepolymers.

Most preferred, the isocyanate prepolymer is the reaction product between diphenylmethane 4,4′-diisocyanate, and/or diphenylmethane 2,2′-diisocyanate, and/or diphenylmethane 2,4′-diisocyanate (MDI) and a polyester polyol based on adipic acid, 2-methyl-1,3-propanediol and 1,4-butanediol, wherein the mole ratio of said polyester polyols to said diisocyanates is 1:1 to 1:5, preferably 1:1.2 to 1:3, more preferably 1:1.5 to 1:2.5, such as 1:2.

In the context of the present invention, the isocyanate prepolymer has an average isocyanate functionality (Fn) of 2 or more than 2, preferably between 2 and 3, more preferably between 2 and 2.7, most preferably between 2 and 2.5.

Additionally, plasticizers can be used in the process for preparing a filament based on thermoplastic polyurethane. Suitable plasticizers are generally known from the state of the art, for example from David F. Cadogan and Christopher J. Howick “Plasticizers” in Ullmann's Encyclopedia of Industrial Chemistry 2000, Wiley-VCH, Weinheim.

Suitable plasticizers are C3-15, preferably C3-10, polycarboxylic acids and their esters with linear or branched C2-30, aliphatic alcohols, benzoates, epoxidized vegetable oils, sulfonamides, organophosphates, glycols and its derivatives, and polyethers. Preferred plasticizers are sebacic acid, sebacates, adipic acid, adipates, glutaric acid, glutarates, phthalic acid, phthalates (for example with C8 alcohols), azelaic acid, azelates, maleic acid, maleate, citric acid and its derivatives, see for example WO 2010/125009, incorporated herein by reference. The plasticizers may be used in combination or individually.

Further additives (as optional component f)) such as for example a polymethylene polyphenyl polyisocyanate may be added in the process for preparing a filament based on thermoplastic polyurethane.

For the purpose of the embodiment of the present invention in connection with TPU, the term “further additives” refers to any substance that will be added to the reaction system of said thermoplastic polyurethane, said isocyanate prepolymer and said plasticizer, but not include the said thermoplastic polyurethane, said isocyanate prepolymer and said plasticizer. Usually such substances include the auxiliaries and additives commonly used in this art.

Within the above mentioned embodiment, it is preferred that
i) the one or more organic diisocyanates (component a)) are selected from diphenylmethane 2,2′-, 2,4′- and/or 4,4′-diisocyanate (MDI), and dicyclohexylmethane 4,4′-, 2,4′- and/or 2,2′-diisocyanate (H12MDI), and/or
ii) the one or more compound reactive toward isocyanate (component b)) are selected from polyhydric alcohols, polyesterols, polyetherols and/or polycarbonate diols, and/or
iii) the one and more chain extenders (compound c)) are selected from 1,4-butanediol, 1,2-ethylenediol and 1,6-hexanediol.

Step a) of the process according to the present invention is carried out by feeding the at least one filament into a cooling device in order to cool down the at least one filament to a temperature T₁ 20° C.

Within step a), it is preferred that the at least filament is cooled down in step a) to a temperature T₁ in the range of −50° C. to 20° C., preferably in the range of −30° C. to 15° C., more preferably in the range of −20° C. to 10° C.

A cooling device as such to be employed within in step a) of the present invention is known to a person skilled in the art. The cooling device may be either positioned inside or outside the housing of the respective 3D extrusion printer. However, in the context of the present invention, it is preferred that the cooling device employed in step a) is at least partially, preferably entirely, positioned inside of the housing of the 3D extrusion printer.

Preferably, the cooling device comprises at least one ventilation unit, at least one peltier element, at least one opening for transportation of filaments and/or at least one cooling body connected to an external source of liquid or gaseous cooling fluids.

Preferably, the at least one filament employed in step a) is provided on at least one spool and fed from the spool into the cooling device, preferably the at least one spool is located outside of the housing of the 3D extrusion printer.

Step b) of the process of the present invention is carried out by transporting the at least one cooled-down filament obtained in step a) to a heating device located inside the printing head of the 3D extrusion printer.

The transporting according to step b) can be carried out by any measure known to a person skilled in the art, for example, the at least one cooled-down filament is transported in step b) by at least one conveyor unit, preferably by at least one heatable conveyor unit and/or by a conveyor unit comprising at least one gear, at least one roll, at least one wheel or at least of friction wheel.

The conveyer unit which may be employed for transporting the cooled-down filament within step b) is known to a person skilled in the art. The conveyer unit may be completely inside the housing of the respective 3D extrusion printer, however, parts of the conveyer unit may also be outside of the respective housing. The latter is the case if, for example, a bowden printer may be employed within the inventive process.

Step c) of the process according to the present invention is carried out by heating the at least one cooled-down filament within the heating device to a temperature T₂, wherein the temperature T₂ is high enough to at least partially melt the at least one filament.

It is preferred that the at least one cool-down filament obtained in step a) is heated within step c) to a temperature T₂, wherein T₂ is at least 1° C., preferably at least 5° C. and more preferably at least 10° C. above the melting point of at least one polymer contained within the respective filament and/or the temperature T₂ is in the range of 140° C. to 240° C., preferably in the range of 160° C. to 220° C.

The heating device employed within step c) of the process according to the present invention is known to a person skilled in the art. The heating device is usually directly connected with the nozzle of the respective 3D extrusion printer. However, the heating device on the one hand and the nozzle on the other hand are usually two devices operated independently from each other. For example, the temperature of the heating device may be the same as the temperature of the nozzle, however, the temperature of the heating device may also be lower than the respective temperature of the nozzle. The temperature of the heating device is usually as high as it is required to keep the respective filament/polymer in a flowable condition.

Step d) of the process according to the present invention is carried out by extruding the at least one heated filament obtained in step c) through the nozzle of the printing head of the 3D extrusion printer in order to obtain at least one extruded strand.

Step e) of the process of the present invention is carried out by forming the 3D object layer by layer from the at least one extruded strand obtained in step d).

Steps d) and e) according to the present invention as such are known to a person skilled in the art. Any conventional 3D extrusion printer, including bowden printers, can be employed within the inventive process. Such conventional 3D extrusion printers usually contain printing heads including nozzles which are known to a person skilled in the art. Due to the extrusion of the respective heated filament obtained in step c), a respective extruded strand of the employed filament is obtained within step d). For example, if the extrusion according to step d) is interrupted for a certain period of time, the employed filament may be replaced by a different filament and the extrusion is continued afterwards. By consequence, a new type of extruded strand may be obtained since the respective filaments may differ in respect of the respective chemical compositions before and after the break. This can be done in order to provide 3D objects having different individual chemical compositions within the respective layers built up step by step (layer by layer) according to step e) of the process of the present invention.

The forming of the 3D object according to step e) in a layer-by-layer mood is known to a person skilled in the art. Usually, the respective printer, in particular the printing head including the nozzle, may be moved either in z-direction and/or in x- or y-direction in order to obtain the respective 3D object step by step. Usually, the 3D object as such is placed on a plate which may be moved in z-direction and/or in x- or y-direction. For the sake of completeness, it is indicated that the x-, y- and z-directions are in relation to a Cartesian coordinate system.

In one embodiment of the present invention, it is preferred that prior to step a) an optional step f) is additionally carried out. Within this embodiment, the at least one filament is heated in an optional step f), which is carried out prior to step a), preferably the at least one filament is heated within step f) to a temperature T₃, which is in the range of between room temperature and below the melting point of at least one polymer contained within the respective filament, more preferably the heating of the at least one filament within step f) is carried out when the filament is still being rolled on the spool and/or when the filament is fed from the spool into the cooling device according to step a).

In respect of the mandatory step a) and/or the optional step f), it is generally preferred within the context of the present invention that
i) the at least one spool contains a heating device and/or is placed inside an oven, and/or
ii) the at least one filament is fed from the spool into the cooling device through a heating tube or isolating tube within step f).

Another subject matter of the present invention is an apparatus to be used within a fused filament fabrication process comprising
i) at least one cooling device for filaments,
ii) at least one first heating device being located in a printing head,
iii) at least one nozzle located in the printing head,
iv) at least one conveyor unit for transporting filaments from the cooling device to the first heating device,

wherein the apparatus is connected to at least one heating tube and/or at least one isolating tube through which at least one filament is fed into the at least one cooling device.

The above-mentioned apparatus is suitable to be employed within the above-mentioned process according to the present invention. The at least one cooling device for filaments is suitable to be employed within step a) of the process of the present invention. The at least one heating device being located in a printing head is suitable for being employed within step c) of the process of the present invention. The at least one nozzle located in the printing head is suitable for carrying out step d) of the process of the present invention. The at least one conveyer unit for transporting filaments from the cooling device to the first heating device is suitable for carrying out step b) of the process of the present invention. The individual parts as such of the above-mentioned apparatus according to the present invention are known to a person skilled in the art.

The apparatus according to the present invention preferably contains at least one of the following parts/units and/or is designed according to at least one of the following options:
i) the at least one conveyor unit is a heatable conveyor unit and/or comprises at least one gear, at least one roll, at least one wheel or at least one friction wheel, and/or
ii) the at least one cooling device is at least partially, preferably entirely, positioned inside of the housing of the 3D extrusion printer, and/or
iii) the cooling device comprises at least one ventilation unit, at least one peltier element, at least one opening for transportation of filaments and/or at least one cooling body connected to an external source of liquid or gaseous cooling fluids, and/or
iv) the at least one cooling device, the at least one conveyor unit and the at least one printing head containing the at least one first heating device and at least one nozzle are located inside the housing of a 3D extrusion printer, and/or
v) the apparatus is a 3D extrusion printer.

Even more preferably, all five above-mentioned options i) to v) are fulfilled within an apparatus according to the present invention.

In addition, the apparatus according to the present invention may comprise the following additional feature:
i) the apparatus is connected to at least one spool for filaments, preferably the at least one spool contains a heating device and/or is placed inside an oven.

Another subject-matter of the present invention is the use of at least one apparatus as described above as a three-dimensional (3D) extrusion printer and/or for printing or producing three-dimensional (3D) objects, preferably within a fused filament fabrication process.

Another embodiment of the present invention is an apparatus to be used within a fused filament fabrication process comprising
i) at least one cooling device for filaments,
ii) at least one first heating device being located in a printing head,
iii) at least one nozzle located in the printing head,
iv) at least one conveyor unit for transporting filaments from the cooling device to the first heating device. The above-mentioned embodiments and preferences with respect to the apparatus apply analogously.

1.-13. (canceled)

14. A process for producing a three-dimensional (3D) object by a fused filament fabrication process employing at least one filament and a three-dimensional (3D) extrusion printer comprising the steps a) to e) as follows:
a) feeding the at least one filament into a cooling device in order to cool down the at least one filament to a temperature T₁≤20° C.,
b) transporting the at least one cooled-down filament obtained in step a) to a heating device located inside the printing head of the 3D extrusion printer,
c) heating the at least one cooled-down filament within the heating device to a temperature T₂, wherein the temperature T₂ is high enough to at least partially melt the at least one filament,
d) extruding the at least one heated filament obtained in step c) through the nozzle of the printing head of the 3D extrusion printer in order to obtain at least one extruded strand,
e) forming the 3D object layer by layer from the at least one extruded strand obtained in step d), wherein the at least one filament is selected from a filament comprising at least one fibrous filler (FF) and at least one polymer.

15. The process according to claim 14, wherein the fibrous filler (FF) is at least one carbon fiber.

16. The process according to claim 14, wherein the at least one filament comprises at least one thermoplastic polyurethane, obtained by polymerization of the following components:
(a) one or more organic diisocyanates,
(b) one or more compounds reactive toward isocyanate,
(c) one or more chain extenders, and
(d) optionally at least one catalyst, and/or
(e) optionally at least one auxiliary, and/or
(f) optionally at least one additive.

17. The process according to claim 16, wherein
i) the one or more organic diisocyanates (component a)) are selected from diphenylmethane 2,2′-, 2,4′- and/or 4,4′-diisocyanate (MDI), and dicyclohexylmethane 4,4′-, 2,4′- and/or 2,2′-diisocyanate (H12MDI), and/or
ii) the one or more compound reactive toward isocyanate (component b)) are selected from polyhydric alcohols, polyesterols, polyetherols and/or polycarbonate diols, and/or
iii) the one and more chain extenders (compound c)) are selected from 1,4-butanediol, 1,2-ethylenediol and 1,6-hexanediol.

18. The process according claim 14, wherein
i) the at least one filament is cooled down in step a) to a temperature T₁ in the range of −50° C. to 20° C., and/or
ii) the cooling device employed in step a) is at least partially positioned inside of the housing of the 3D extrusion printer, and/or
iii) the cooling device comprises at least one ventilation unit, at least one peltier element, at least one opening for transportation of filaments and/or at least one cooling body connected to an external source of liquid or gaseous cooling fluids.

19. The process according to claim 14, wherein
i) the at least one cooled-down filament is transported in step b) by at least one conveyor unit, and/or by a conveyor unit comprising at least one gear, at least one roll, at least one wheel or at least of friction wheel, and/or
ii) the at least one cooled-down filament obtained in step a) is heated within step c) to a temperature T₂, wherein T₂ is at least 1° C. above the melting point of at least one polymer contained within the respective filament and/or the temperature T₂ is in the range of 140° C. to 240° C.

20. The process according to claim 14, wherein the at least one filament employed in step a) is provided on at least one spool and fed from the spool into the cooling device.

21. The process according to claim 20, wherein the at least one filament is heated in an optional step f), which is carried out prior to step a).

22. The process according to claim 20, wherein
i) the at least one spool contains a heating device and/or is placed inside an oven, and/or
ii) the at least one filament is fed from the spool into the cooling device through a heating tube or isolating tube within step f).

23. An apparatus to be used within a fused filament fabrication process comprising
i) at least one cooling device for filaments,
ii) at least one first heating device being located in a printing head,
iii) at least one nozzle located in the printing head,
iv) at least one conveyor unit for transporting filaments from the cooling device to the first heating device,
wherein the apparatus is connected to at least one heating tube and/or at least one isolating tube through which at least one filament is fed into the at least one cooling device.

24. The apparatus according to claim 23, wherein
i) the at least one conveyor unit is a heatable conveyor unit and/or comprises at least one gear, at least one roll, at least one wheel or at least one friction wheel, and/or
ii) the at least one cooling device is at least partially, positioned inside of the housing of the 3D extrusion printer, and/or
iii) the cooling device comprises at least one ventilation unit, at least one peltier element, at least one opening for transportation of filaments and/or at least one cooling body connected to an external source of liquid or gaseous cooling fluids, and/or
iv) the at least one cooling device, the at least one conveyor unit and the at least one printing head containing the at least one first heating device and at least one nozzle are located inside the housing of a 3D extrusion printer, and/or
v) the apparatus is a 3D extrusion printer.

25. The apparatus according to claim 23, wherein the apparatus is connected to at least one spool for filaments.

26. A method comprising utilizing the at least one apparatus according to claim 23 as a three-dimensional (3D) extrusion printer and/or for printing or producing three-dimensional (3D) objects.
